(19) United States
(12) Patent Application Publication
(10) Pub. No.: US 2022/0183281 A1
(43) Pub. Date: Jun. 16, 2022

(54) Microcapsules

(71) Applicant: LANXESS Deutschland GmbH, Cologne (DE)

(72) Inventors: Hermann Uhr, Leverkusen (DE); Katrin Moews, Dortmund (DE); Thomas Sames, Pittsburgh, PA (US)

(73) Assignee: LANXESS Deutschland GmbH, Cologne (DE)

(21) Appl. No.: 17/415,170

(22) PCT Filed: Dec. 16, 2019
(86) PCT No.: PCT/EP2019/085237

§ 371 Date: Jan. 21, 2022

(30) Foreign Application Priority Data
Dec. 18, 2018 (EP) 18213638.2

(51) Int. Cl. A01N 25/28; A01N 43/653; A01N 43/80

(52) U.S. Cl. CPC A01N 25/28; A01N 43/80; A01N 43/653

(57) ABSTRACT

Microcapsules comprising
a) at least one melamine-formaldehyde polymer as capsule material and
b) as biocide at least
   b1) OIT and
   b2) propiconazole and/or 3-iodo-2-propynyl butylcarbamate (IPBC),
      characterized in that the weight ratio of OIT to the sum total of propiconazole and/or IPBC is 5:1 to 1:5, preferably from 1:1 to 1:5, in particular from 1:1.5 to 1:3.

The present invention relates to microcapsules comprising at least two specific biocides and at least one melamine-formaldehyde polymer, to a method for their production, and to their use for the protection of industrial materials.

Industrial materials, such as sealing compounds, protected from microbiological attack by means of microencapsulated biocides are already known from the prior art.

WO2008/080963 (DE102006061890A1) describes sealing compounds comprising specific isothiazolinones such as, for example, 2-n-octyl-4-isothiazolin-3-one (OIT) as biocide, the biocide being incorporated in microparticles composed of a resin.

With respect to the microparticle leaching behaviour of OIT, there is, however, still potential for improvement. It is therefore an object of the present invention to improve the leaching behaviour of OIT.

It has now been found that specific mixing ratios of OIT and propiconazole and/or 3-iodo-2-propynyl butylcarbamate (IPBC) can distinctly reduce the microparticle leaching behaviour of OIT.

The invention therefore provides microcapsules comprising
a) at least one melamine-formaldehyde polymer as capsule material and
b) as biocide at least
   b1) OIT and
   b2) propiconazole and/or 3-iodo-2-propynyl butylcarbamate (IPBC),

characterized in that the weight ratio of OIT to the sum total of propiconazole and/or IPBC is 5:1 to 1:5, preferably from 1:1 to 1:5, in particular from 1:1.5 to 1:3.

Microcapsule

The microcapsules according to the invention are preferably distinguished by having a volume-averaged particle size of from 0.3 to 100 μm. Preferably, the microcapsules according to the invention have a volume-averaged particle size of from 5 to 80 μm. Particularly preferably, the microcapsules according to the invention are furthermore distinguished by the D90 value, determined via laser diffraction as a volume-weighted distribution as described in the experimental section, being preferably less than 60 μm.

Preferably, the microparticles have a spherical shape. Said shape has the advantage of a high volume with low surface area, resulting in striking water having a low wetting area.

Capsule Material a)

The term “melamine-formaldehyde polymers” is preferably to be understood as meaning resins in which melamine has been polycondensed with formaldehyde under suitable conditions. For their preparation, melamine is generally reacted with formaldehyde in molar excess.

The microencapsulation material of the microcapsules according to the invention can additionally also comprise further aminoplast resins. Aminoplast resins are generally understood as meaning polycondensation products of carbonyl compounds with compounds containing NH groups. For example, melamine-formaldehyde resins, melamine-urea-formaldehyde resins or melamine-phenol-formaldehyde resins. In this connection, melamine-formaldehyde resins which are water-miscible and exhibit especially a high to very high reactivity are of particular interest. Particular preference is given to alkylated tri- or tetraethers and very particular preference is given to methylated tri- or tetraethers. Further possible aminoplast resins that can be added to the melamine-formaldehyde polymer are for example aminoplast resins of a compound containing NH groups and acetaldehyde or glyoxal. Furthermore, urethane resins, cyanamide resins and dicyanamide resins, aniline resins, sulfonamide resins or mixtures of these resins can be added. These resins and their production are known to the person skilled in the art.

Preferably, up to 50% by weight, based on the total weight of capsule material, of other aminoplast resins can be added to the melamine-formaldehyde polymer. Preferably, the capsule material comprises, however, at least 95% by weight of melamine-formaldehyde polymer, particularly preferably at least 99% by weight of melamine-formaldehyde polymer.

Owing to the incorporation of the biocide of component b) in the microparticles, it is released only to a very slight extent in the case of use in industrial materials such as, for example, coating compositions. Furthermore, the industrial material remains biocidally active, since the active ingredient remains in the material, and said active ingredient can therefore be used in correspondingly low concentrations. In practical use, the biocide is released only in a slowed manner.

Preferably, the weight ratio of capsule material a) to biocide of component b) is 1:4 to 4:1.

In a preferred embodiment of the method according to the invention, it was found that the leaching behaviour can be improved yet further if the capsule material a) is used substoichiometrically with respect to the biocide b). In a particularly preferred embodiment of the method according to the invention, the weight ratio of capsule material a) to biocide of component b) is 1:4 to 1:1.5, in particular from 1:4 to 1:2, even though a higher release rate and thus poorer leaching behaviour would have to be expected with reduced capsule wall material.

Despite low material usage for the capsule wall, it was possible to observe a reduced release of OIT for this embodiment.

Biocide b)

Although WO2008/080963 mentions in principle the concomitant use of further active ingredients in addition to OIT within a wide range, possible active ingredients are, however, selected merely on the grounds of the desired mode of action in the particular application area. In the present invention, the use of OIT in the same amount or in a substoichiometric amount in relation to the sum total of propiconazole and/or IPBC, preferably in a weight ratio of OIT to the sum total of propiconazole and/or IPBC of from 5:1 to 1:5, preferably from 1:1 to 1:5, in particular from 1:1.5 to 1:3, has a very positive effect on the leaching behaviour.

In a preferred embodiment, the biocide of component b) that is used comprises at least b1) OIT and b2) propiconazole, preferably without IPBC; in particular, the biocide of component b) consists of OIT and propiconazole to an extent of more than 99% by weight, in particular to an extent of 100% by weight.

In a likewise preferred embodiment, the biocide of component b) that is used comprises at least b1) OIT and b2) IPBC, preferably without propiconazole; in particular, the biocide of component b) consists of OIT and IPBC to an extent of more than 99% by weight, in particular to an extent of 100% by weight.

Further Additives c)

The microcapsules according to the invention can additionally comprise further components. Preferably, these are protective colloids, especially water-soluble polymers different from component a), very particularly preferably polyacrylates, partly hydrolysed polyvinyl acetate, polyvinyl alcohol, polyvinylpyrrolidone, cellulose ethers (tylose), such as methylcellulose, hydroxyethylcellulose or hydroxypropylmethylcellulose for example, starch, proteins, gum arabic, alginates, pectins, gelatin or mixtures of these compounds present. The protective colloids are preferably present in an amount of from 0.2 to 5% by weight, based on the microcapsule. In this connection, the protective colloid present can be situated inside the capsule, in the capsule wall or outside on the capsule wall. Particularly preferably, the protective colloid used is polyacrylate or a mixture of gum arabic and polyacrylate.

Method of Production

The invention further encompasses a method for producing the microcapsules according to the invention, characterized in that it comprises at least the following steps:
a) depositing microencapsulation material comprising melamine-formaldehyde polymer onto biocides of component b) and then
b) treating the biocide-containing microcapsules which form at a temperature which is at least 5° C., preferably at least 10° C., in particular at least 20° C., higher than the deposition temperature in step a).

Step a)

In the method for producing the microcapsules according to the invention, it is for example possible to use the biocides of component b) in water or in a solvent not miscible with water, which are then dispersed. Preferably, an aqueous suspension or emulsion of the biocides of component b) is used when producing the microcapsules according to the invention.

Preferably, in this connection, the biocides of components b1) and b2) are initially charged in a water-containing charge, especially with at least one protective colloid of component c), as described above for example, preferably a polyacrylate and optionally a further protective colloid such as gum arabic. Said charge is preferably adjusted to a temperature of from 50 to 85° C., in particular from 55 to 75° C.

Before the addition of component a), it is preferred that the charge be preferably adjusted to a pH within the range from 0 to 6.99, preferably from 1.0 to 4.0, particularly preferably from 2.50 to 3.50 and very particularly preferably from 2.80 to 3.20, measured under standard conditions of 20° C.

The pH can be adjusted by using both inorganic and organic acids such as, for example, hydrochloric acid, sulfuric acid, phosphoric acid or citric acid, oxalic acid, acetic acid, formic acid, acidic salts or mixtures thereof.

The microencapsulation material comprising melamine-formaldehyde polymer, for example in the form of its aqueous solution, is then added to said charge for the purpose of deposition on the biocide. The addition is preferably carried out over a period of from 30 minutes to 24 hours.

The microencapsulation material is preferably added in the form of its aqueous solution, in particular with a solids content of from 20 to 85% by weight. The pH of such a solution is preferably 7 to 11.

The method comprises the use of melamine-formaldehyde polymers which are deposited on compounds of the formula (I) through change in the pH and thermally treated and thus form the microcapsule. The melamine-formaldehyde polymers are commercially available, for example Saduren® (BASF AG), Maprenal® (Ineos Melamines), Resimene® (Ineos Melamines), Cymel® (Allnex), Madurit® (Ineos Melamines), Quecodur® (Thor GmbH), or can also be prepared from melamine and formaldehyde by known methods, as described for example in WO 2008/000797 A2.

Further auxiliaries known to the person skilled in the art, such as protective colloids for example, can also be added to the melamine-formaldehyde polymer.

Before the addition of the melamine-formaldehyde polymer, an emulsion is preferably generated by means of a sufficiently thorough mixing and high shear forces. To generate sufficiently high shear forces, rotor-stator systems such as Ultraturrax, Dispermix, Dispermat, ultrasound, high-pressure dispersers, nozzle units with axial flow-through or similar systems known to the person skilled in the art are generally used.

The addition of the melamine-formaldehyde polymer to the dispersion, in particular suspension or emulsion of the biocides of component b), preferably in the presence of protective colloids c), can, for example, be done immediately or over a period of at least one minute, preferably over a period of from 30 minutes to 24 hours, particularly preferably over a period of from 1 to 24 hours and very particularly preferably over a period of at least 2 to 6 hours.

In the method according to the invention for producing the microcapsules according to the invention, the shear forces preferably used are preferably reduced in the course of the addition of polymer. Without wishing to commit to any scientific theory, it is suspected that the high shear forces preferred for the maintenance of the emulsion hamper the formation of a sufficiently thick polymer layer. When the reduction is carried out and to what extent it is carried out vary depending on the chosen rotor-stator system.

In the method according to the invention for producing the microcapsules according to the invention, the deposition temperature of the melamine-formaldehyde polymer can be varied within a broad range; preferably, the deposition is done at a temperature of from 40 to 87° C., preferably within a range from 59 to 85° C. and particularly preferably within a range from 69 to 83° C.

Alternatively, the melamine-formaldehyde polymer preferably dissolved in water can also first be added to the charge and only afterwards can the deposition on the surface of the biocide of component b) be effected by setting an acidic pH.

Suitable conditions for the deposition of the microencapsulation material on the biocide of component b) can be determined experimentally in a few preliminary experiments without great effort.

Step b)

In the method according to the invention for producing the microcapsules according to the invention, a subsequent thermal treatment is carried out. Without wishing to commit to any scientific theory, it is suspected that groups which are not yet crosslinked or not yet polymerized are crosslinked or polymerized by the thermal treatment. After the deposition of the melamine-formaldehyde polymer, a treatment of the deposited melamine-formaldehyde polymer can be carried out at temperatures which are lower than, identical to or higher than the deposition temperature. Preferably, the treatment is carried out with stirring. In an alternative embodiment, the microcapsules according to the invention can also be chemically treated.

Furthermore, the thermal treatment of the microcapsules according to the invention is preferably carried out at a temperature which is not higher than 97° C., preferably at 50 to 95° C., especially at 70 to 95° C., very particularly preferably at 80 to 90° C.

With respect to the preferred duration of the thermal post-treatment, it varies depending on the temperature. For example, it can last from 1 to 48 hours, preferably from 4 to 24 hours, preferably from 8 to 20 hours.

In the method according to the invention for producing the microcapsules according to the invention, it is likewise possible to initially charge a suspension or emulsion of the biocides of component b) and of the melamine-formaldehyde polymer with optionally auxiliaries, such as, for example, protective colloids or else further aminoplast resins, to heat it to the deposition temperature, and to only then set the above-mentioned pH of from 0 to 6.99 so that the resin precipitates.

The method according to the invention for producing the microcapsules according to the invention can be carried out at any desired pressure. Preferably, the method according to the invention for producing the microcapsules according to the invention is carried out at ambient pressure.

The microcapsules according to the invention can, for example, be converted into a suspension in a manner known to the person skilled in the art by addition of auxiliaries, in-can preservative and thickeners without work-up. In this connection, preference is given to adjusting the pH of the resulting aqueous formulation to pH 7 to 10, preferably from 8 to 9.

In an alternative embodiment, the microcapsules according to the invention can be isolated after production, for example by filtration, and dried at room temperature or by gentle heating. It is, however, also possible to dry and to isolate the microencapsulation material by spray-drying or freeze-drying. Preferably, the microcapsules according to the invention are separated off by filtration and then dried.

The microcapsules according to the invention are suitable in particular for use in or as biocidal, especially fungicidal agents. Therefore, the invention also encompasses biocidal agents comprising microcapsules according to the invention and also the use of the microcapsules according to the invention as biocidal agent or in biocidal agents.

The microcapsules according to the invention are distinguished by high efficacy and their broad spectrum of activity against fungi.

Examples include microorganisms of the following genera:

Alternaria sp., such as A. tenuis,

Aspergillus sp., such as A. niger, A. ustus

Chaetomium sp., such as C. globosum,

Coniophora sp., such as C. puetana,

Lentinus sp., such as L. tigrinus,

Penicillium sp, such as P. glaucum, P. citrinum, P. brevicaule

Polyporus sp., such as P. versicolor,

Aureobasidium sp., such as A. pullulans,

Sclerophoma sp., such as S. pityophila,

Trichoderma sp., such as T. viride,

Cladosporium sp., such as C. herbarum,

Stachybotrys sp., such as S. chartarum

Paecilomyces sp., such as P. variotii

Geotrichum sp., such as G. candidum

Fusarium sp., such as F. oxysporum, F. solani.

The biocidal agents according to the invention can be present in any desired formulation, such as, for example, in the form of dispersions, powders or granules.

In principle, preferred types of formulation are essentially dependent on the intended use and the physical properties required for this. However, since these are known, it is customary practice for the person skilled in the art to ascertain a preferred type of formulation in a few experiments.

The formulations can additionally also comprise further substances, such as stabilizers, in-can preservatives and further biocides, such as for example fungicides, algicides, insecticides, acaricides, nematicides, radicides and herbicides or mixtures thereof, preferably fungicides or algicides or mixtures thereof, very particularly preferably algicides.

Besides the microcapsules according to the invention, the biocidal agents can optionally furthermore comprise various auxiliaries. For the auxiliaries specified below, there is in each case independently of one another also the possibility that they are not present. Possible auxiliaries are for example:
Interface-active substances, such as, for example, surfactants. Surfactants may for example be nonionic, cationic and amphoteric surfactants, preferably anionic surfactants. Anionic surfactants are for example alkyl sulfates, alkyl ether sulfates, alkylarylsulfonates, alkyl succinates, alkyl sulfosuccinates, N-alkoyl sarcosinates, acyl taurates, acyl isethionates, alkyl phosphates, alkyl ether phosphates, alkyl ether carboxylates, alpha-olefinsulfonates, in particular the alkali metal and alkaline earth metal salts, for example sodium, potassium, magnesium, calcium, and ammonium and triethanolamine salts. The alkyl ether sulfates, alkyl ether phosphates and alkyl ether carboxylates can in each case have for example from 1 to 10 ethylene oxide or propylene oxide units, preferably 1 to 3 ethylene oxide units. Suitable examples include sodium lauryl sulfate, ammonium lauryl sulfate, sodium lauryl ether sulfate, ammonium lauryl ether sulfate, sodium lauryl sarcosinate, sodium oleyl succinate, ammonium lauryl sulfosuccinate, sodium dodecylbenzenesulfonate, triethanolamine dodecylbenzenesulfonate. The biocidal agents according to the invention can comprise here for example from 0.01 to 10% by weight, preferably from 0.2 to 8% by weight, particularly preferably from 0.3 to 5% by weight and very particularly preferably from 0.5 to 3% by weight of interface-active substances.
Defoamers. The defoamers used are generally interface-active substances which are only weakly soluble in the surfactant solution. Preferred defoamers are those which derive from natural fats and oils, petroleum derivatives or silicone fluids.
Wetting agents, such as, for example, alkali metal salts, alkaline earth metal salts and ammonium salts of aromatic sulfonic acids, for example ligno-, phenol-, naphthalene- and dibutylnaphthalenesulfonic acid, and of fatty acids, alkyl- and alkylarylsulfonates, alkyl, lauryl ether and fatty alcohol sulfates, and salts of sulfated hexa-, hepta- and octadecanols or fatty alcohol glycol ethers, condensation products of sulfonated naphthalene and its derivatives with formaldehyde, condensation products of naphthalene or of naphthalenesulfonic acids with phenol and formaldehyde, polyoxyethylene octylphenol ether, ethoxylated isooctyl-, octyl- or nonylphenol, alkylphenol or tributylphenyl polyglycol ethers, tris-sterylphenyl ether ethoxylates, alkylaryl polyether alcohols, isotridecyl alcohol, fatty alcohol ethylene oxide condensates, ethoxylated castor oil, polyoxyethylene alkyl ethers or polyoxypropylene, lauryl alcohol polyglycol ether acetate, sorbitol esters, lignosulfite waste liquors or methylcellulose. The biocidal agents according to the invention can comprise here for example from 0.01 to 8% by weight, preferably from 0.2 to 6% by weight, particularly preferably from 0.3 to 5% by weight and very particularly preferably from 0.5 to 3% by weight of wetting agents.
Emulsifiers, such as, for example, sodium, potassium and ammonium salts of straight-chain aliphatic carboxylic acids of chain length C₁₀-C₂₀, sodium hydroxyoctadecanesulfonate, sodium, potassium and ammonium salts of hydroxy fatty acids of chain length C₁₀-C₂₀ and the sulfation or acetylation products thereof, alkyl sulfates, also as triethanolamine salts, alkyl-(C₁₀-C₂₀)-sulfonates, alkyl-(C₁₀-C₂₀)-arylsulfonates, dimethyldialkyl-(C₈-C₁₈)-ammonium chloride, acyl, alkyl, oleyl and alkylaryl oxethylates and their sulfation products, alkali metal salts of sulfosuccinic acid esters with aliphatic saturated monohydric alcohols of chain length C₄-C₁₆, sulfosuccinic acid 4-esters with polyethylene glycol ethers of monohydric aliphatic alcohols of chain length C₁₀-C₁₂ (disodium salt), sulfosuccinic acid 4-esters with polyethylene glycol nonylphenyl ether (disodium salt), sulfosuccinic acid bis-cyclohexyl ester (sodium salt), lignosulfonic acid and the calcium, magnesium, sodium and ammonium salts thereof, polyoxyethylene sorbitan monooleate with 20 ethylene oxide groups, resin acids, hydrogenated and dehydrogenated resin acids and the alkali metal salts thereof, dodecylated diphenyl ether disulfonic acid sodium, and copolymers of ethylene oxide and propylene oxide with a minimum content of 10% by weight of ethylene oxide. Preferably, the emulsifiers used are: sodium lauryl sulfate, sodium lauryl ether sulfate, ethoxylated (3 ethylene oxide groups); the polyethylene glycol (4-20)ethers of oleyl alcohol, and the polyethene oxide (4-14)ethers of nonylphenol. The biocidal agents according to the invention can comprise here for example from 0.01 to 15% by weight, preferably from 0.02 to 8% by weight, particularly preferably from 0.05 to 6% by weight and very particularly preferably from 0.1 to 5% by weight of emulsifiers.
Dispersants, such as, for example, alkylphenol polyglycol ethers. The biocidal agents according to the invention can comprise here for example from 0.01 to 15% by weight, preferably from 0.02 to 8% by weight, particularly preferably from 0.05 to 6% by weight and very particularly preferably from 0.1 to 5% by weight of dispersants.
Stabilizers, such as, for example, cellulose and cellulose derivatives. The biocidal agents according to the invention can comprise here for example from 0.01 to 6% by weight, preferably from 0.01 to 3% by weight, particularly preferably from 0.01 to 2% by weight and very particularly preferably from 0.01 to 1% by weight of stabilizers.
Stabilizers, such as, for example, antioxidants, radical scavenges or UV absorbers.
Adhesives or protective colloids, such as, for example, carboxymethylcellulose, natural and synthetic pulverulent, granular or latex-like polymers, such as gum arabic, polyvinyl alcohol, polyvinyl acetate, and natural phospholipids, such as cephalins and lecithins, and synthetic phospholipid, and paraffin oils. The biocidal agents according to the invention can comprise here for example from 0.01 to 8% by weight, preferably from 0.05 to 4% by weight, particularly preferably from 0.2 to 3% by weight and very particularly preferably from 0.2 to 2% by weight of adhesives.
Spreading agents, such as, for example, isopropyl myristate, polyoxyethylene nonylphenyl ether and polyoxyethylene laurylphenyl ether. The biocidal agents according to the invention can comprise here for example from 0.01 to 20% by weight, preferably from 0.1 to 10% by weight, particularly preferably from 0.1 to 5% by weight and very particularly preferably from 0.1 to 2% by weight of spreading agents.
Fragrances and dyes, such as, for example, inorganic pigments, for example iron oxide, titanium oxide, Prussian blue, and organic dyes, such as alizarin, azo and metallophthalocyanine dyes, and trace nutrients, such as salts of iron, manganese, boron, copper, cobalt, molybdenum and zinc. The biocidal agents according to the invention can comprise here for example in each case from 0.001 to 4% by weight, preferably from 0.01 to 1% by weight, particularly preferably from 0.01 to 0.8% by weight of fragrances and dyes.
Buffer substances, buffer systems or pH regulators. The biocidal agents according to the invention can comprise here for example in each case from 0.01 to 10% by weight, preferably from 0.1 to 5% by weight of buffer substances, buffer systems or pH regulators.
Thickeners, such as, for example, polysaccharides, xanthan gum, sodium or magnesium silicates, heteropolysaccharides, alginates, carboxymethylcellulose, gum arabic or polyacrylic acids, preferably xanthan gum.
Dedusting agents are for example polyglycols and polyglycol ethers. The biocidal agents according to the invention can comprise here for example in each case from 0.01 to 2% by weight, preferably from 0.05 to 1% by weight, particularly preferably from 0.1 to 0.5% by weight of dedusting agents.
As flow agents or release agents it is possible to use for example highly dispersed silica or Mg salts of fatty acids. To improve the flowability of the solids, the biocidal agents according to the invention can comprise here in each case from 0.01 to 5% by weight, preferably from 0.05 to 3% by weight, particularly preferably from 0.1 to 2% by weight of flow agents.
In-can preservatives are for example biocides, bactericides and fungicides. The biocidal agents according to the invention can comprise here for example in each case from 0.01 to 2% by weight, preferably from 0.05 to 1% by weight of in-can preservatives.
Antifreeze agents are for example urea, urea derivatives and glycols. The biocidal agents according to the invention can comprise here for example in each case from 0.01 to 10% by weight, preferably from 0.5 to 5% by weight of antifreeze agents.

The overall content of the aforementioned auxiliaries in the biocidal agents is for example from 0.001 to 20% by weight, preferably from 0.1 to 15% by weight and particularly preferably from 0.1 to 10% by weight.

Preferred biocidal agents include solid formulations, such as, for example, powder mixtures or water-dispersible granules (WG); in addition to the microcapsules, these can also comprise solid auxiliaries such as, for example, natural stone flours, such as kaolins, clay earths, talc, marble, chalk, quartz, attapulgite, montmorillonite or diatomaceous earth, or synthetic inorganic substances, such as highly dispersed silica, aluminium oxide and silicates, or mixtures thereof.

It is thus possible according to the invention for, firstly, lower amounts of active ingredient to be used for furnishing and, secondly, considerably longer durations of action to be achieved.

The solid formulations can be obtained in a manner known per se, for example by intimate mixing of the microcapsules according to the invention with the solid auxiliaries. Furthermore, the solid formulations can be obtained by drying, for example spray-drying, of a liquid formulation.

Preferred solid formulations comprise for example from 10 to 100% by weight of the microcapsules according to the invention, preferably from 15 to 98% by weight.

Likewise preferred biocidal agents include liquid formulations, for example dispersions, which can also be present in the form of gels or pastes.

Preferred liquid formulations are preferably aqueous dispersions.

The liquid formulations such as, in particular, the dispersions can be produced in a manner known per se without isolation of the microcapsules, for example by addition of common formulation auxiliaries. In this connection, preference is given to adjusting the pH of the resulting aqueous formulation to pH 7 to 10, preferably from 8 to 9. Alternatively, they can for example be produced in a manner known per se by using a stirrer to mix together intimately with one another the microencapsulated active ingredients and the further substances which are to be present in the liquid formulation.

The liquid formulations generally comprise from 2 to 95% by weight, preferably from 5 to 75% by weight and very particularly preferably from 5 to 50% by weight of the microcapsules according to the invention. Likewise preferably, they have a pH of pH 7 to 10.

The invention further provides for the use of the microcapsules according to the invention or of the biocidal agents according to the invention for the protection of industrial materials, and also industrial materials comprising the biocidal agents according to the invention or microcapsules according to the invention.

Examples of industrial materials are construction materials, wood, engineered wood, wood-plastic composites, sealing compounds, joint seals, plastics, films, stone slabs, textiles such as, for example, tarpaulins and tents, textile composites, coating compositions such as, for example, paints, wall paints, outside house paints, exterior paints, interior paints, emulsion paints, silicate paints, varnishes, concrete, cement, mortar or plasters, preferably silicate-bonded, mineral, resin-bonded or silicone-resin-bonded plasters, synthetic resin plasters, wood coatings, wood glazes, concrete coatings, roof tile coatings, sealing compounds or textile coatings.

Further applications for coating compositions according to the invention are found in not only the construction industry, but also medical technology, textile industry, rubber industry, sealant industry, agricultural industry and laboratory technology.

The advantage of the invention can be seen in the microcapsules according to the invention showing a superior leaching behaviour, because it is reduced, preferably even with simultaneously low material usage for the capsule material. What are thus possible according to the invention are both the use of lower substance amounts for the protection of coating compositions and the achievement of considerably longer durations of action.

The examples which follow illustrate the present invention.

### EXAMPLES

General

Leaching Test Procedure for Microcapsules Comprising OIT:

A quantity of the formulation comprising 500 ppm OIT (based on 100 g) was weighed in a 100 ml screw-top glass vessel and topped up with water to 100 g. The screw-top glass vessel was closed and the sample was shaken on a circular shaker at 250 revolutions per minute and 20° C. After 24 hours, 1 ml of sample was collected using a pipette and transferred to a reaction vessel. The sample was centrifuged at 14 000 revolutions per minute for 6 minutes and the supernatant was analysed by means of high-performance liquid chromatography.

Microcapsule Production:

The microcapsules are produced in a 1000 ml flat-flange pot with impeller stirrer (400-600 rpm) and Ultraturrax (16 000-16 200 rpm for emulsification and then, at the start of the addition of Maprenal, 0 rpm).

In the examples which follow, the following substances were used:

| Name | Amount |
|---|---|
| Gum arabic solution (4% by weight) | 40.5 g |
| Coadis ™ BR3 (50% by weight in H₂O) (dispersion | 8.1 g |
| reagent; aqueous polyacrylate salt solution from | |
| Coatex) | |
| Water | 536 g |
| SILOFOAM ®SRE (silicone antifoam emulsion | 3.2 g |
| defoamer from Wacker) | |
| Citric acid | for setting of pH |
| | 2.99 |
| Active ingredient | 161 g |
| Maprenal ® MF 921w/85WA water solution (1:1) | 161 g |
| (melamine-formaldehyde crosslinker resin from INEOS | |
| Melamines) having a pH of 8 | |

### Examples 1 to 7

Procedure:

The active-ingredient capsules for examples 1 to 7 (Propi/OIT in various ratios. Active ingredient:resin 2.4:1) are produced as follows:

Gum arabic solution, Coadis® BR3 solution and water are initially charged together with Silfoam®SRE defoamer. The pH is adjusted to 2.99 by addition of citric acid solution (50% by weight). Thereafter, the mixture is heated to 60° C., while the active ingredients propiconazole and OIT are added and are emulsified with the aid of an Ultraturrax. Once the mixture has reached 60° C., the Maprenal® water solution (1:1) is added dropwise over a period of 2-3 hours.

After 10% of Maprenal® water solution has been added dropwise, the mixture is only stirred with the impeller stirrer. After complete addition, the mixture is heated to 90° C. and stirred overnight.

Formulation: After cooling to room temperature, the pH is adjusted to pH 8 by addition of sodium hydroxide solution (50% by weight). 0.2% Soprophor® S25, 0.2% Preventol® BMS, 5% urea and Rhodopol-G® are added, yielding a homogeneous formulation.

Comparative example A (only OIT; active ingredient:resin 2.4:1): Gum arabic solution, Coadis® BR3 solution and water are initially charged together with Silfoam®SRE defoamer. The pH is adjusted to 2.99 by addition of citric acid solution (50% by weight). The mixture is transferred to a 1 L flat-flange beaker and heating to 60° C. is started. OIT is added and is emulsified with the aid of an Ultraturrax. Once 60° C. are reached, the Maprenal® water solution (1:1) is added dropwise over a period of 2-3 hours. After 10% of Maprenal® water solution has been added dropwise, the mixture is only stirred with the impeller stirrer. After complete addition, the mixture is heated to 90° C. and stirred overnight.

Formulation: After cooling to room temperature, the pH is adjusted to pH 8 by addition of sodium hydroxide solution (50% by weight). 0.2% Soprophor® S25, 0.2% Preventol® BMS, 5% urea and Rhodopol-G® are added, yielding a homogeneous formulation.

TABLE 1
Release of OIT from microcapsules after 24 hours of leaching.

| | Ratio of | |
|---|---|---|
| Example | propiconazole: OIT | OIT [ppm] |
| 1 | 5:1 | 27.3 ppm |
| 2 | 4:1 | 23.5 ppm |
| 3 | 3:1 | 21.0 ppm |
| 4 | 2:1 | 16.0 ppm |
| 5 | 1:2 | 56.9 ppm |
| 6 | 1:5 | 63.6 ppm |
| 7 | 1:10 | 116.7 ppm |

TABLE 2
Release of OIT from microcapsules after 24
hours of leaching.

| Comparative example | OIT [ppm] |
|---|---|
| A | 148 ppm |

The active-ingredient capsules for examples 8 to 9 (IPBC/OIT in various ratios. Active ingredient:resin 2.4:1) are produced as follows:

Gum arabic solution, Coadis® BR3 solution and water are initially charged together with Silfoam®SRE defoamer. The pH is adjusted to 2.99 by addition of citric acid solution (50% by weight). The mixture is heated to 70° C. After 70° C. are reached, IPBC and OIT are added and are emulsified using an Ultraturrax at 10 600 rpm. Thereafter, the Maprenal® water solution (1:1) is added dropwise over a period of 2-3 hours. After 10% of Maprenal® water solution has been added dropwise, the mixture is only stirred with the impeller stirrer. After complete addition, the mixture is heated to 80° C. and stirred overnight.

Formulation: After cooling to room temperature, the pH is adjusted to pH 8 by addition of sodium hydroxide solution (50% by weight). 0.2% Soprophor® S25, 0.2% Preventol® BMS, 5% urea and Rhodopol-G® are added, yielding a homogeneous formulation.

TABLE 3
Release of OIT from microcapsules after 24 hours of leaching.

| Example | Ratio of IPBC: OIT | OIT [ppm] |
|---|---|---|
| 8 | 3:1 | 16.1 ppm |
| 9 | 2:1 | 17.1 ppm |

### Example 10—More Resin (Propi/OIT 2:1; Resin:Active Ingredient 1:1)

The following substances were used to prepare the microcapsules in the following example:

| Name | Amount |
|---|---|
| Gum arabic solution (4% by weight) | 40.5 g |
| Coadis ™ BR3 (50% by weight in H₂O) (dispersion | 8.1 g |
| reagent; aqueous polyacrylate salt solution from | |
| Coatex) | |
| Water | 548 g |
| SILOFOAM ®SRE (silicone antifoam emulsion | 3.2 g |
| defoamer from Wacker) | |
| Citric acid | for setting |
| | of pH 2.99 |
| Propiconazole | 107.3 g |
| OIT | 53.7 g |
| Maprenal ® MF 921w/85WA solution (189 g of Maprenal + | 350 g |
| 161 g of water) (melamine-formaldehyde crosslinker | |
| resin from INEOS Melamines) having a pH of 8 | |

Procedure:

Gum arabic solution, Coadis® BR3 solution and water are initially charged together with Silfoam®SRE defoamer. The pH is adjusted to 2.99 by addition of citric acid solution (50% by weight). Thereafter, OIT is added and is emulsified with the aid of an Ultraturrax (16 200 rpm). The mixture is heated to 60° C. After addition of propiconazole, the Maprenal® water solution (1:1) is added dropwise over a period of 2-3 hours. After 10% of Maprenal® water solution has been added dropwise, the mixture is only stirred with the impeller stirrer (500 rpm). After complete addition, the mixture is heated to 90° C. and stirred overnight.

Formulation: After cooling to room temperature, the pH is adjusted to pH 8 by addition of sodium hydroxide solution (50% by weight). 0.2% Soprophor® S25, 0.2% Preventol® BMS, 5% urea and Rhodopol-G® are added, yielding a homogeneous formulation.

TABLE 4
Release of OIT from microcapsules differing in resin/active ingredient ratio
after 24 hours of leaching.

| | | Ratio of | |
|---|---|---|---|
| | Ratio of | resin:active | |
| Example | propiconazole: OIT | ingredient | OIT [ppm] |
| 4 | 2:1 | 1:2.4 | 16.0 ppm |
| 10 | 2:1 | 1:1 | 27.8 ppm |

Results/Conclusions:

Comparison of OIT with Propi/OIT Capsules:

With the aid of the described method, it was possible to produce OIT capsules which lead to a slowed release of the active ingredient (comparative example A). Surprisingly, it was possible slow the release of OIT many times over by the addition of propiconazole (examples 1 to 7). It was found here that there is a preferred ratio of propiconazole to OIT at which this effect is particularly pronounced. If the proportion of propiconazole is increased further, the capsules become more permeable again for OIT.

Variation of Wall Material to Active Ingredient:

WO2008/080963 describes a ratio of 1:1 as the only ratio of wall material to OIT. The person skilled in the art would presume that the use of more wall material (ratio of wall material to active ingredient of greater than 1:1) leads to a thicker resin layer, this giving rise to a denser capsule than with less wall material (ratio of wall material to active ingredient of 1:2.4). Surprisingly, this is not the case. As shown by examples 4 and 10 for the propiconazole/OIT encapsulations, the capsules in which more resin was used have a poorer retention of OIT than those with less resin.

1. Microcapsules comprising
a) at least one melamine-formaldehyde polymer as capsule material and
b) as biocide at least
b1) OIT and
b2) propiconazole and/or 3-iodo-2-propynyl butylcarbamate (IPBC),
wherein the weight ratio of OIT to the sum total of propiconazole and/or IPBC is 5:1 to 1:5.

2. Microcapsules according to claim 1, wherein the weight ratio of capsule material a) to biocide of component b) is 1:4 to 4:1.

3. Microcapsules according to claim 1, wherein the weight ratio of capsule material a) to biocide of component b) is 1:4 to 1:1.5.

4. Microcapsules according to claim 1, comprising as biocide of component b) at least b1) OIT and b2) propiconazole.

5. Microcapsules according to claim 1, wherein the biocide of component b) consists of OIT and propiconazole to an extent of more than 99% by weight.

6. Microcapsules according to claim 1, comprising as biocide of component b) at least b1) OIT and b2) IPBC.

7. Microcapsules according to claim 1, wherein the biocide of component b) consists of OIT and IPBC to an extent of more than 99% by weight.

8. Microcapsules according to claim 1, wherein the microcapsules have a volume-averaged particle size of from 0.3 to 100 μm.

9. Microcapsules according to claim 1, wherein the capsule material additionally comprises aminoplast resins, aminoplast resins of a compound containing NH groups and acetaldehyde or glyoxal, urethane resins, cyanamide resins and dicyanamide resins, aniline resins, sulfonamide resins or mixtures of these resins.

10. Microcapsules according to claim 1, wherein it comprises at least one protective colloid.

11. Method for producing microcapsules according to claim 1, wherein it comprises at least the following steps:
a) depositing microencapsulation material comprising melamine-formaldehyde polymer onto biocides of component b) and then
b) treating the biocide-containing microcapsules which form at a temperature which is at least 5° C. higher than the deposition temperature in step a).

12. Biocidal agents comprising microcapsules according to claim 1.

13. (canceled)

14. Industrial materials comprising the biocidal agents according to claim 12.

15. A process for the protection of industrial materials comprising contacting the industrial materials with the microcapsules according to claim 1.
